(19) United States
(12) Patent Application Publication
(10) Pub. No.: US 2025/0271145 A1
(43) Pub. Date: Aug. 28, 2025

(54) OVEN APPLIANCE AND METHOD FOR SEASONING CYCLE OPERATION

(71) Applicant: Haier US Appliance Solutions, Inc., Wilmington, DE (US)

(72) Inventor: Tianxiao Ma, Chicago, IL (US)

(21) Appl. No.: 18/587,342

(22) Filed: Feb. 26, 2024

(51) Int. Cl. F24C 7/08; F24C 3/12; G06V 20/50; H05B 6/64

(52) U.S. Cl. CPC F24C 7/085; F24C 3/128; H05B 6/6447; G06V 20/50

(57) ABSTRACT

A cooking appliance and method for operation are provided. The cooking appliance includes a controller configured to cause the cooking appliance to perform operations that include obtaining an input parameter at least partially determinative of a seasoning cycle to be executed at the oven appliance. The seasoning cycle includes a temperature parameter, a heating duration, and a cycle quantity. The operations include heating the cooking chamber based on the seasoning cycle, and obtaining a start signal indicative of a cookware presence at the cooking chamber. The start signal corresponds to commencing the heating duration of the cookware for the seasoning cycle. The operations include transmitting an end signal corresponding to an end of the seasoning cycle.

### FIELD OF THE INVENTION

The present subject matter relates generally to oven appliances, and more particularly to a method for seasoning cycle operation at an oven appliance.

### BACKGROUND OF THE INVENTION

Oven appliances generally include a cabinet that defines a cooking chamber for cooking food items therein, such as by baking or broiling the food items. In order to perform the cooking operation, oven appliances typically include one or more heat sources, or heating elements, provided in various locations within the cooking chamber. These heat sources may be used together or individually to perform various specific cooking operations, such as baking, broiling, roasting, and the like.

Certain cookware, such as cast iron cookware or various nonstick cookware, generally requires an application of a layer or coating to mitigate corrosion, reduce an amount of fat used for cooking, or generally promote use and longevity of the cookware. The coating is applied in a process called “seasoning”, such as by applying a layer of oil or fat to the cookware and subjecting the cookware to heat over a period of time. However, the time and intensity of heat may lead to undesired effects, such as smoke buildup, excessive oil or fat residue, or insufficient sealing and setting of the oil or fat at the cookware.

Accordingly, an oven appliance, and a method for seasoning cycle operation for an oven appliance, that obviates one or more of these drawbacks would be beneficial and advantageous.

### BRIEF DESCRIPTION OF THE INVENTION

Aspects and advantages of the invention will be set forth in part in the following description, or may be obvious from the description, or may be learned through practice of the invention.

An aspect of the present disclosure is directed to a method of operating an oven appliance. The method includes obtaining an input parameter at least partially determinative of a seasoning cycle to be executed at the oven appliance. The seasoning cycle includes a temperature parameter, a heating duration, and a cycle quantity. The operations include heating the oven appliance based on the seasoning cycle, and obtaining a start signal indicative of a cookware presence at the oven appliance. The start signal corresponds to commencing the heating duration of the cookware for the seasoning cycle. The operations include transmitting an end signal corresponding to an end of the seasoning cycle.

Another aspect of the present disclosure is directed to a cooking appliance including a cabinet forming a cooking chamber, and a controller configured to execute instructions that causes the cooking appliance to perform operations. The operations include obtaining an input parameter at least partially determinative of a seasoning cycle to be executed at the oven appliance, the seasoning cycle including a temperature parameter, a heating duration, and a cycle quantity; heating the cooking chamber based on the seasoning cycle; obtaining a start signal indicative of a cookware presence at the cooking chamber, wherein the start signal corresponds to commencing the heating duration of the cookware for the seasoning cycle; and transmitting an end signal corresponding to an end of the seasoning cycle.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary oven appliance with the door in a closed position according to exemplary embodiments of the present disclosure.

FIG. 2 provides a front view of an interior of a cooking chamber of an exemplary oven appliance according to exemplary embodiments of the present disclosure.

FIG. 3 provides a flowchart outlining steps of a method of operating an oven appliance according to embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. In the context of an angle or direction, such terms include values within ten degrees greater or less than the stated direction. For example, “generally vertical” includes directions within ten degrees of vertical in any direction, e.g., clockwise or counter-clockwise.

Embodiments provided herein generally provide a cooking appliance, such as an oven appliance, and a method of operation, such as for applying a coating to a cookware surface, such as a seasoning cycle, a bluing cycle, or other passivation process, or related processes for protecting against corrosion or mitigate sticking at cookware.

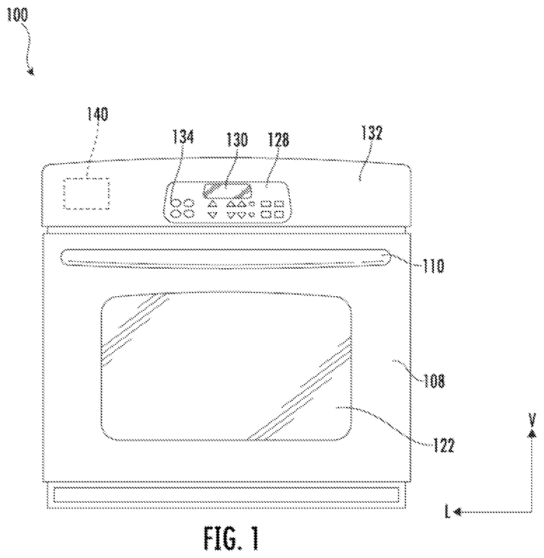

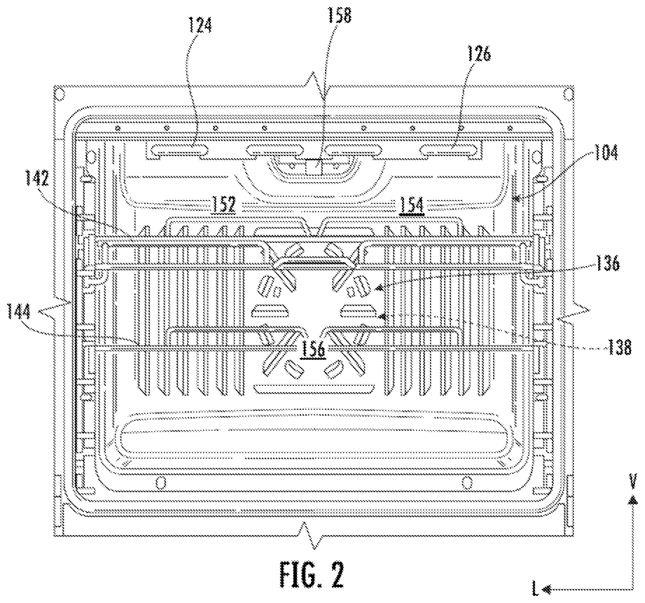

Referring to FIGS. 1-2, for this exemplary embodiment, oven appliance 100 may include an insulated cabinet 102 with an interior cooking chamber 104 defined by a top wall 112, a bottom wall 114, a back wall 116, and a pair of opposing side walls 118. Cooking chamber 104 is configured for the receipt of cookware and one or more food items to be cooked. Oven appliance 100 includes a door 108 pivotally mounted, e.g., with one or more hinges (not shown), to cabinet 102 at the opening 106 of cabinet 102 to permit selective access to cooking chamber 104 through opening 106. A handle 110 may be mounted to door 108 to assist a user with opening and closing door 108. For example, a user can pull on handle 110 to open or close door 108 and access cooking chamber 104.

Referring still to FIGS. 1-2, oven appliance 100 may include a seal (not shown) between door 108 and cabinet 102 that assists with maintaining heat and cooking vapors within cooking chamber 104 when door 108 is closed as shown in FIGS. 1-2. A glass pane 122, or multiple glass panes, provide for viewing the contents of cooking chamber 104 when door 108 is closed and assist with insulating cooking chamber 104. A baking rack may be positioned in cooking chamber 104 for the receipt of food items or utensils containing food items. For example, the cooking chamber may include a first baking rack 142 and a second baking rack 144. Each of first baking rack 142 and second baking rack may be conveniently moved into and out of cooking chamber 104 when door 108 is open (i.e., via rails provided on each of side walls 118). First baking rack 142 may be arranged above second baking rack 144 (e.g., in the vertical direction V). Thus, first baking rack 142 may be closer to top wall 112 of cabinet 102 than second baking rack 144.

One or more heating elements may be provided at the top, bottom, or both of cooking chamber 104, and may provide heat to cooking chamber 104 for cooking. Such heating element(s) can be gas, electric, microwave, or a combination thereof. For example, in the embodiment shown in FIG. 2, oven appliance 100 includes a first top heating element 124 and a second top heating element 126, where second top heating element 126 is positioned adjacent to first top heating element 124. Other configurations with or without a wall may be used as well. For instance, a bottom heating element may be incorporated in addition to, or alternatively to, the first and second top heating elements 124 and 126.

In some embodiments, oven appliance 100 may also have a convection heating element 136 and convection fan 138 positioned adjacent back wall 116 of cooking chamber 104. Convection fan 138 may be powered by a convection fan motor. Further, convection fan 138 may be a variable speed fan i.e., the speed of fan 138 may be controlled or set anywhere between and including, e.g., zero and one hundred percent (0%-100%). In certain embodiments, oven appliance 100 also includes a bidirectional triode thyristor (not shown), i.e., a triode for alternating current (TRIAC), to regulate the operation of convection fan 138 such that the speed of fan 138 may be adjusted during operation of oven appliance 100. The speed of convection fan 138 may be determined by controller 140 (FIG. 1). In addition, a sensor such as, e.g., a rotary encoder, a Hall effect sensor, or the like, may be included at the base of fan 138 to sense the speed of fan 138. The speed of fan 138 may be measured in, e.g., revolutions per minute (“RPM”). In some embodiments, the convection fan 138 may be configured to rotate in two directions, e.g., a first direction of rotation and a second direction of rotation opposing the first direction of rotation. For example, in some embodiments, reversing the direction of rotation, e.g., from the first direction to the second direction or vice versa, may still direct air from the back of the cavity. As another example, in some embodiments reversing the direction results in air being directed from the top and/or sides of the cavity rather than the back of the cavity.

In various embodiments, more than one convection heater, e.g., more than one convection heating elements 136 and/or convection fans 138, may be provided. In such embodiments, the number of convection fans and convection heaters may be the same or may differ, e.g., more than one convection heating element 136 may be associated with a single convection fan 138. Similarly, top heating elements and/or bottom heating elements may be provided in various combinations, e.g., one top heating element with two or more bottom heating elements, two or more top heating elements 124, 126 with no bottom heating element, etc.

Referring back to FIG. 1, oven appliance 100 may include a user interface 128 having a display 130 positioned on an interface panel 132 and having a variety of user input devices, e.g., controls 134. Interface 128 may allow the user to select various options for the operation of oven 100 including, e.g., various cooking and cleaning cycles. Operation of oven appliance 100 may be regulated by a controller 140 that is operatively coupled, i.e., in communication with, user interface 128, heating elements 124, 126, 136 and other components of oven 100 as will be further described.

For example, in response to user manipulation of the user interface 128, controller 140 may operate the heating element(s). Controller 140 may receive measurements from one or more temperature sensors such as sensors described below. Controller 140 may also provide information such as a status indicator, e.g., a temperature indication, to the user with display 130. Controller 140 may also be provided with other features as will be further described herein.

Controller 140 may include a memory and one or more processing devices such as microprocessors, CPUs, or the like, such as general or special purpose microprocessors operable to execute programming instructions or micro-control code associated with operation of oven appliance 100. The memory may represent random access memory such as DRAM or read only memory such as ROM or FLASH. In one embodiment, the processor executes programming instructions stored in memory. The memory may be a separate component from the processor or may be included onboard within the processor. The memory may store information accessible by the processor(s), including instructions that can be executed by processor(s). For example, the instructions can be software or any set of instructions that when executed by the processor(s), cause the processor(s) to perform operations. For the embodiment depicted, the instructions may include a software package configured to operate the system to, e.g., execute the exemplary methods described below. Controller 140 may also be or include the capabilities of either a proportional (P), proportional-integral (PI), or proportional-integral-derivative (PID) control for feedback-based control implemented with, e.g., temperature feedback from one or more sensors.

Controller 140 may be positioned in a variety of locations throughout oven appliance 100. In the illustrated embodiment, controller 140 is located next to user interface 128 within interface panel 132. In other embodiments, controller 140 may be located under or next to the user interface 128 otherwise within interface panel 132 or at any other appropriate location with respect to oven appliance 100. In the embodiment illustrated in FIG. 1, input/output (“I/O”) signals are routed between controller 140 and various operational components of oven appliance 100 such as heating elements 124, 126, 136, convection fan 138, controls 134, display 130, alarms, and/or other components as may be provided. In one embodiment, user interface 128 may represent a general purpose I/O (“GPIO”) device or functional block.

In the illustrated embodiments, the user input device is provided as touch type controls 134. However, it should be understood that controls 134 and the configuration of oven appliance 100 shown in FIG. 1 are illustrated by way of example only. For example, the user interface 128 may be provided as a touchscreen which provides both the display 130 and the controls 134. As further examples, the user interface 128 may include various input components, such as one or more of a variety of electrical, mechanical, or electro-mechanical input devices including rotary dials, push buttons, and touch pads. User interface 128 may include other display components, such as a digital or analog display device designed to provide operational feedback to a user. In some embodiments, user interface 128 may be in communication with controller 140 via one or more signal lines or shared communication busses. In other embodiments, the user interface 128 may be configured as an external computing device or remote user interface device, such as a smart phone, tablet, or other device capable of connecting to the controller 140. For example, the remote user interface device may be a handheld user interface with a display thereon, e.g., a touchscreen display. The remote user device may connect to the controller 140 wirelessly using any suitable wireless connection, such as wireless radio, WI-FI®, BLUETOOTH®, ZIGBEE®, laser, infrared, and any other suitable device or interface. For example, in some embodiments, the remote user interface may be an application or “app” executed by a remote user interface device such as a smart phone or tablet. Signals generated in controller 140 may operate appliance 100 in response to user input via the user interface 128.

While oven appliance 100 is shown as a wall oven, the present invention could also be used with other cooking appliances such as, e.g., a stand-alone oven, an oven with a stove-top, or other configurations of such ovens. Numerous variations in the oven configuration are possible within the scope of the present subject matter. For example, variations in the type and/or layout of the controls 134, as mentioned above, are possible. As another example, the oven appliance 100 may include multiple doors 108 instead of or in addition to the single door 108 illustrated. Such examples include a dual cavity oven, a French door oven, and others. The examples described herein are provided by way of illustration only and without limitation.

In some embodiments, such as shown in FIG. 2, cooking chamber 104 may be divided into several distinct heating zones. For instance, cooking chamber 104 may include a first heating zone 152, a second heating zone 154, and a third heating zone 156. It should be understood that any suitable number of heating zones may be incorporated into cooking chamber 104, including more or less than three heating zones. Each of the heating zones may be spaced apart from one another (e.g., along the vertical direction V, the lateral direction L, and/or transverse direction T). In other words, the first heating zone 152 may be spaced apart from the second heating zone 154 and the third heating zone 156, etc. Accordingly, each heating zone may be controlled separately from one another (e.g., to or at a different temperature or power level, using a different criterion, or using a different heating cycle).

In one example, first heating zone 152 corresponds to first top heating element 124. In other words, first top heating element 124 may be configured to provide heat to the first heating zone 152. First top heating element 124 may be located predominantly to a first side of cooking chamber 104 in the lateral direction L (e.g., proximal to the first side, distal to an opposite second side, and/or otherwise corresponding to first heating zone 152). Accordingly, first top heating element 124 may provide heat predominantly to first heating zone 152 while having reduced heating impact on second heating zone 154 and third heating zone 156. First heating zone 152 may be positioned at or near a top of cooking chamber 104. For example, first heating zone 152 may correspond to first baking rack 142 (e.g., a first half thereof). Accordingly, first heating zone 152 may be a first broil zone.

Similarly, second heating zone 154 may correspond to second top heating element 126. In other words, second top heating element 126 may be configured to provide heat to the second heating zone 154. Second top heating element 126 may be located predominantly to the second side of cooking chamber 104 in the lateral direction L (e.g., proximal to the second side, distal to the first side, and/or otherwise corresponding to second heating zone 154). Accordingly, second top heating element 126 may provide heat predominantly to second heating zone 154 while having reduced heating impact on first heating zone 152 and third heating zone 156. Second heating zone 154 may be positioned at or near a top of cooking chamber 104. Additionally, or alternatively, second heating zone 154 may be adjacent to first heating zone 152 in the lateral direction L. For example, second heating zone 154 may correspond to first baking rack 142 (e.g., a second half thereof). Accordingly, second heating zone 154 may be a second broil zone. In some embodiments, second top heating element 126 does not overlap with first heating zone 152 (e.g., in a vertical direction). For example, first top heating element 124 is positioned vertically over first heating zone 154 and second heating element 126 is positioned vertically over second heating zone 156.

Third heating zone 156 may be defined spaced apart from first heating zone 152 and second heating zone 154. For instance, third heating zone 156 may be located beneath first heating zone 152 and second heating zone 154 in the vertical direction V, as shown in FIG. 2. In some embodiments, third heating zone 156 is a baking zone. Accordingly, third heating zone 156 may receive heat primarily from a third heating element, e.g., a bottom heating element, or convection heating element 136. However, this embodiment is not limited, and third heating zone 156 may receive heat from a bottom heating element, a side heating element, or a combination of available heating elements.

Each of the first heating zone 152, second heating zone 154, and third heating zone 156 may be controlled according to an individual seasoning cycle. For example, each of the first heating zone 152, second heating zone 154, and third heating zone 156 may be controlled according to a category or type of cookware identified in each zone, such as based on size, geometry, or quality or quantity of seasoning coating (e.g., oil or fat) at the cookware, such as described further herein. The individual seasoning cycles may be classified as power levels, and may be the same, or, in some instances, different from each other. For example, a first seasoning cycle or power level for the first heating zone 152 may be a first seasoning parameter (e.g., first duration, temperature, or combination thereof, or combinations of changes thereof) for a first type of cookware to be seasoned placed in the first heating zone 152. Simultaneously, a second seasoning cycle or power level for the second heating zone 154 may be a second seasoning parameter (e.g., second duration, temperature, or combination thereof, or combinations of changes thereof) for a second type of cookware to be seasoned placed in the second heating zone 154. Simultaneously, a third seasoning cycle or power level for the third heating zone 156 may be a third seasoning parameter (e.g., third duration, temperature, or combination thereof, or combinations of changes thereof) for a third type of cookware to be seasoned placed in the third heating zone 156. It should be appreciated that the oven appliance 100 may include a quantity of simultaneous seasoning cycles or power levels up to a quantity of heating zones at the oven appliance 100. It should also be appreciated that the oven appliance 100 may be configured to perform various seasoning cycles based on a determined cookware, such as further described herein.

In some embodiments, an imaging device or camera 158 is provided within cooking chamber 104. Generally, camera 158 may be a video camera, a digital camera, or other imaging device with an electronic image sensor, e.g., a charge coupled device (CCD) or a CMOS sensor. Camera 158 may be configured to obtain images in visible light, infrared light (IR), or other portions of the electromagnetic spectrum. When assembled, camera 158 is in communication (e.g., wired or wireless communication) with controller 140 such that controller 140 may receive a signal from camera 158 corresponding to the image captured by camera 158. Camera 158 may be configured to capture images of cooking chamber 104 (e.g., an interior of cabinet 102). For instance, camera 158 may capture images of cookware placed in each of first heating zone 152, second heating zone 154, and/or third heating zone 156, etc. One or more cameras 158 may be located in any suitable location within cooking chamber 104, such that each of first heating zone 152, second heating zone 154, and/or third heating zone 156 are visible to camera 158. For example, as shown in FIG. 2, camera 158 may be located at or near a top of cooking chamber 104 in the vertical direction V (e.g., between the first and second heating elements 124, 126 along the lateral direction L). Additionally or alternatively, camera 158 may be located at or near a center of cooking chamber 104 in the lateral direction L. The specific location of camera 158 is not limited, however, and one of ordinary skill in the art would appreciate multiple potential locations for camera 158. Embodiments of the oven appliance 100 include the camera 158 operably and communicatively coupled to the controller 134 to generate and transmit signals to the controller 134, such as based on one or more steps of a method of operating the cooking appliance such as further described herein.

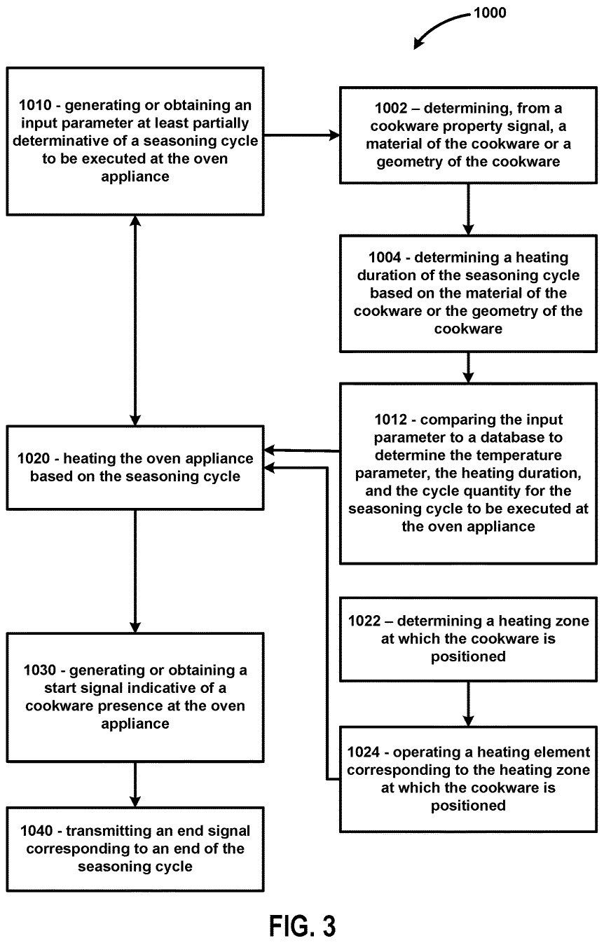

FIG. 3 provides a flowchart outlining steps of a method of operating a cooking appliance (hereinafter, “method 1000”). For example, the method 1000 described herein with respect to FIG. 3 may be used to operate the cooking appliance described above with respect to FIGS. 1-2. Additionally, or alternatively, method 1000 described herein with respect to FIG. 3 may be used to operate other suitable cooking appliances. Embodiments of the method 1000 may include steps of a method for seasoning cycle operation.

Generally, a user may begin a seasoning process by applying a coat of oil or fat (hereinafter, “coating”) to cookware. The substance used for the coating (i.e., a coating type) may vary and, as a result, a desired heat and/or duration of the seasoning cycle may vary based, at least in part, on the coating type. For instance, the coating type may vary between different types of oils or fats, such as, but not limited to, vegetable oil, canola oil, vegetable or animal shortening, lard, beef tallow, etc., or combinations thereof. A desired temperature for the seasoning cycle may vary based on the coating type. For instance, the desired temperature for the seasoning cycle may range from 150 degrees Celsius to temperatures up to or above 260 degrees Celsius, or up to 450 degrees Celsius.

The desired temperature, and duration thereof, may vary based on the coating type, a material of the cookware (e.g., cast iron, carbon steel, etc.), a geometry (e.g., surface area) of the cookware, a thickness of the coating (e.g., based on spraying, wiping, pouring, or other method of application of the coating type to the cookware, or differences from user to user), or combinations thereof.

The user positions the cookware in a cooking chamber (e.g., cooking chamber 104). The user may position the cookware at the cooking chamber without applying the coating, such as to begin a process for removing a previously-applied coating from the cookware. Alternatively, the user may position the cookware at the cooking chamber after applying the coating, such as to begin a process for forming a bioplastic layer at the cookware.

Method 1000 includes at 1010 generating or obtaining an input parameter at least partially determinative of a seasoning cycle to be executed at the oven appliance. The seasoning cycle includes a temperature parameter, a heating duration, and a cycle quantity.

In various embodiments, obtaining the input parameter includes obtaining a coating type signal. The coating type signal corresponds to a coating type, such as an oil, a fat, or a bioplastic substrate applied to the cookware, such as described above. As provided above, the coating type, and the corresponding coating type signal, at least in part, corresponds to the temperature parameter of the seasoning cycle. For instance, the coating type corresponding to an avocado oil may include a smoke point at approximately 271 degrees Celsius, and flaxseed oil may include a smoke point at approximately 107 degrees Celsius, and various other oils may include smoke points therebetween. The relatively low smoke point of the coating type corresponding to flaxseed oil may facilitate forming the coating at the cookware relatively quickly. As such, the temperature, duration, or both, of the seasoning cycle may increase or decrease based on the coating type corresponding to the coating type signal. Adjusting the seasoning cycle based on the coating type may promote forming the coating at the cookware, or furthermore, reduce a period of time over which smoke may build up at the oven appliance or a surrounding kitchen.

In some embodiments, obtaining the input parameter includes obtaining a coating application signal. The coating application signal corresponds to whether the coating at the cookware is sprayed, wiped, poured, or previously-applied to the cookware. The coating application signal may generally correspond to or indicate a thickness of the oil or fat applied to the cookware. For instance, spraying, wiping, or pouring the oil or fat onto the cookware may form thicknesses of the oil or fat that may alter the duration of the seasoning cycle.

In some instances, the coating application signal corresponding to a previously-applied coating at the cookware determines, at least in part, a preparation cycle for the seasoning cycle. The preparation cycle includes a temperature parameter, a heating duration, and a cycle quantity for removing the previously-applied coating from the cookware. For instance, the cookware may be positioned at the cooking chamber and run through the preparation cycle prior to the user applying the coating to the cookware, such as to remove the previously-applied coating from the cookware (e.g., a factory applied coating at new cookware). As such, one or more cycles of the seasoning cycle may include the preparation cycle, including a temperature and duration corresponding to removing the previously-applied coating different from the coating type corresponding to the coating type signal.

In various embodiments, obtaining the input parameter includes obtaining one or more cookware property signals corresponding to a material of the cookware or a geometry of the cookware. The geometry may correspond to whether the cookware is a pan, a pot, a Dutch oven, etc., or having various diameters or depths. The material may correspond to cast iron, carbon steel, stainless steel, aluminum, or other material as may be known for seasoning. The cookware property may, at least in part, determine temperature or duration of heat applied to the cookware. For instance, seasoning may be required for cast iron and carbon steel cookware to prevent corrosion and mitigate sticking. Stainless steel and aluminum may generally not require seasoning for corrosion protection, however, seasoning may mitigate sticking and promote thermal emissivity (e.g., such as may promote browning of foods).

In some embodiments, obtaining the input parameter includes generating, via an imaging device (e.g., camera 158), one or more cookware property signals corresponding to a material of the cookware or a geometry of the cookware. For instance, the imaging device may be configured to determine geometry, e.g., a surface area, of the cookware. The controller 140 may be configured to determine or adjust the temperature or duration of the seasoning cycle based on the geometry, e.g., size or surface area, of the cookware.

In still some embodiments, method 1000 includes at 1002 determining, from the cookware property signal, the material of the cookware, the geometry of the cookware, or both. Method 1000 includes at 1004 determining the heating duration of the seasoning cycle based on the material of the cookware, the geometry of the cookware, or both.

In some embodiments, method 1000 includes at 1012 comparing the input parameter to a database to determine the temperature parameter, the heating duration, and the cycle quantity for the seasoning cycle to be executed (e.g., at step 1020) at the oven appliance. The database may be accessed by a controller (e.g., controller 140), such as stored locally in memory at the controller, or accessed at a remote server or device, such as via internet or other network connection.

Method 1000 includes at 1020 heating the oven appliance based on the seasoning cycle. In some embodiments, obtaining the input parameter includes obtaining a heating zone signal corresponding to a heating zone (e.g., heating zone 152, 154, 156) at which the cookware is positioned. For instance, the heating zone signal may include a user input signal at which the user indicates at which heating zone the cookware is, or will be, positioned for the seasoning cycle.

In some embodiments, obtaining the input parameter includes at 1022 determining, via an imaging device (e.g., camera 158), a heating zone at which the cookware is positioned. In still some embodiments, heating the oven appliance based on the seasoning cycle includes at 1024 operating a heating element (e.g., heating element 124, 126, 136) corresponding to the heating zone at which the cookware is positioned.

Method 1000 includes at 1030 generating or obtaining a start signal indicative of a cookware presence at the oven appliance. The start signal corresponds to commencing the heating duration of the cookware for the seasoning cycle. In some embodiments, obtaining the start signal includes obtaining a user input signal (e.g., from a user, such as via controller 134) indicative of the cookware positioned at the oven, such as after the user has positioned the cookware at the cooking chamber. In still some embodiments, obtaining the start signal includes obtaining or generating, via an imaging device (e.g., camera 158), an image signal corresponding to the cookware presence at the oven appliance.

Method 1000 includes at 1040 transmitting an end signal corresponding to an end of the seasoning cycle. The end signal may include an audio signal, a visual signal, or combination thereof, indicating to the user that the seasoning cycle, or one or more cycles or portions thereof, has ended. For instance, the end signal may correspond to completion of one or more steps of the method 1000 described herein.

Embodiments of the method 1000 may include a cooling duration, such as after completion of the seasoning cycle, or after application of heat for a duration such as described herein, or between cycles.

Various embodiments of the method 1000 may include steps performed iteratively, such as steps and periods of time for applying heat, maintaining temperature, and allowing for cooling. Cycles described herein may include a one or more warm-up, heating, heating duration, and cooling periods. Method 1000 may include performing one or more of the steps in repetition, such as, but not limited to, steps for determining a seasoning cycle, determining a cookware property, determining a heating duration, or determining a cycle quantity, or steps for generating, obtaining, or transmitting signals accordingly.

Embodiments of the oven appliance 100 provided herein may include an interconnected system of appliances, such as connected via a wired or wireless communication bus to transmit and receive data over a network.

Embodiments of the oven appliance 100 and method 1000 provided herein may decrease an amount of hands-on time required entering oven settings, timers, or tracking an amount of time spent cooling down. Embodiments provided herein may reduce waste and improve energy efficiency by avoiding heating the oven for longer durations or higher temperatures than necessary for completing a seasoning process. Embodiments provided herein may facilitate optimization of temperature or duration of the seasoning cycle, such as by determining temperatures and durations more closely aligned to physical properties of the coating type.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating an oven appliance, the method comprising:
obtaining an input parameter at least partially determinative of a seasoning cycle to be executed at the oven appliance, the seasoning cycle comprising a temperature parameter, a heating duration, and a cycle quantity;
heating the oven appliance based on the seasoning cycle;
obtaining a start signal indicative of a cookware presence at the oven appliance, wherein the start signal corresponds to commencing the heating duration of the cookware for the seasoning cycle; and
transmitting an end signal corresponding to an end of the seasoning cycle.

2. The method of claim 1, the method comprising:
comparing the input parameter to a database to determine the temperature parameter, the heating duration, and the cycle quantity for the seasoning cycle to be executed at the oven appliance.

3. The method of claim 1, wherein obtaining the input parameter comprises obtaining a coating type signal, wherein the coating type signal corresponds, at least in part, to the temperature parameter of the seasoning cycle.

4. The method of claim 3, wherein the coating type signal corresponds to a coating type comprising an oil, a fat, or a bioplastic substrate applied to the cookware.

5. The method of claim 1, wherein obtaining the input parameter comprises obtaining one or more cookware property signals corresponding to a material of the cookware or a geometry of the cookware.

6. The method of claim 1, wherein obtaining the input parameter comprises obtaining a heating zone signal corresponding to a heating zone at the oven at which the cookware is positioned.

7. The method of claim 1, wherein obtaining the input parameter comprises obtaining a coating application signal, the coating application signal corresponding to whether the coating at the cookware is sprayed, wiped, poured, or previously-applied to the cookware.

8. The method of claim 7, wherein obtaining the coating application signal corresponding to the previously-applied coating determines, at least in part, a preparation cycle for the seasoning cycle, wherein the preparation cycle comprises a temperature parameter, a heating duration, and a cycle quantity for removing the previously-applied coating from the cookware.

9. The method of claim 1, wherein obtaining the start signal indicative of the cookware presence at the oven appliance comprises obtaining a user input signal indicative of the cookware positioned at the oven.

10. The method of claim 1, wherein obtaining the start signal indicative of the cookware presence at the oven appliance comprises obtaining, via an imaging device, an image signal corresponding to the cookware presence at the oven appliance.

11. The method of claim 10, wherein obtaining the input parameter comprises generating, via the imaging device, one or more cookware property signals corresponding to a material of the cookware or a geometry of the cookware.

12. The method of claim 11, the method comprising:
determining from the cookware property signal, the material of the cookware, the geometry of the cookware, or both; and
determining the heating duration of the seasoning cycle based on the material of the cookware, the geometry of the cookware, or both.

13. The method of claim 10, wherein obtaining the input parameter comprises determining, via the imaging device, a heating zone at the oven at which the cookware is positioned.

14. The method of claim 13, wherein heating the oven appliance based on the seasoning cycle comprises operating a heating element corresponding to the heating zone at which the cookware is positioned.

15. A cooking appliance, comprising:
a cabinet forming a cooking chamber; and
a controller configured to execute instructions that causes the cooking appliance to perform operations, the operations comprising:
obtaining an input parameter at least partially determinative of a seasoning cycle to be executed at the oven appliance, the seasoning cycle comprising a temperature parameter, a heating duration, and a cycle quantity;
heating the cooking chamber based on the seasoning cycle;
obtaining a start signal indicative of a cookware presence at the cooking chamber, wherein the start signal corresponds to commencing the heating duration of the cookware for the seasoning cycle; and
transmitting an end signal corresponding to an end of the seasoning cycle.

16. The cooking appliance of claim 15, the operations comprising:
comparing, via the controller, the input parameter to a database to determine the temperature parameter, the heating duration, and the cycle quantity for the seasoning cycle to be executed at the oven appliance.

17. The cooking appliance of claim 15, wherein obtaining the input parameter comprises obtaining a coating type signal, wherein the coating type signal corresponds, at least in part, to the temperature parameter of the seasoning cycle based on a coating type comprising an oil, a fat, or a bioplastic substrate applied to the cookware.

18. The cooking appliance of claim 17, wherein obtaining the input parameter comprises one or more of:
obtaining one or more cookware property signals corresponding to a material of the cookware or a geometry of the cookware;
obtaining a heating zone signal corresponding to a heating zone at the oven at which the cookware is positioned; or
obtaining a coating application signal, the coating application signal corresponding to whether the coating at the cookware is sprayed, wiped, poured, or previously-applied to the cookware.

19. The cooking appliance of claim 15, the cooking appliance comprising an imaging device positioned within the cooking chamber, the operations comprising:
generating, via the imaging device, an image signal corresponding to the cookware presence at the oven appliance;
generating, via the imaging device, one or more cookware property signals corresponding to a material of the cookware or a geometry of the cookware;
determining, via the controller from the cookware property signal, the material of the cookware, the geometry of the cookware, or both; and
determining, via the controller, the heating duration of the seasoning cycle based on the material of the cookware, the geometry of the cookware, or both.

20. The cooking appliance of claim 15, the cooking appliance comprising an imaging device positioned within the cooking chamber,
wherein obtaining the input parameter comprises determining, via the imaging device, a heating zone at the oven at which the cookware is positioned, and
wherein heating the oven appliance based on the seasoning cycle comprises operating a heating element corresponding to the heating zone at which the cookware is positioned.
